(19) United States
(12) Patent Application Publication
(10) Pub. No.: US 2001/0021356 A1
(43) Pub. Date: Sep. 13, 2001

(54) Device in the form of a container and/or closure

(76) Inventor: Franz Konrad, Schwanenstadt (AT)

Correspondence Address: COLLARD & ROE, P.C., 1077 Northern Boulevard, Roslyn, NY, 11576, US

(21) Appl. No.: 09/728,981

(22) Filed: Dec. 4, 2000

(30) Foreign Application Priority Data
Dec. 6, 1999 (AT) A 2044/99

(51) Int. Cl. B01L 3/00

(52) U.S. Cl. 422/102; 422/55; 435/304.1; 215/230; 215/247

(57) ABSTRACT

The invention relates to a device (1) in the form of a container (2) having a container interior (9) partially delimited by a container body (8) comprising a container shell (3) having an external and an internal shell surface (10, 12) and a container base (7) arranged at one of two end faces (5, 6) of the container shell (3) disposed at oppositely lying ends in the direction of a container central axis (4). The second end face (5) of the container shell (3) surrounds a container opening (14). At least one data medium (16) for recording and reproducing and/or processing data is arranged on the container body (8) by means of an appliance (17) provided with an adhesive and/or in the container body (8), in particular being joined thereto and/or arranged in the container interior (9) and/or joined thereto.

### BACKGROUND OF THE INVENTION

1. Field of the Invention

The invention relates to

a device in the form of a container, in particular a storage container, e.g. for containing fluids of biological origin or biological assays, having a container interior partially delimited by a main container body comprising a container shell having an external and an internal shell surface and a container base arranged at one of two end faces of the container shell disposed at oppositely lying ends in the direction of a container central axis, the second end face of the container shell surrounding a container opening, and at least one data medium,

a device in the form of a closure for a container opening, having a closure body comprising a closing cap and a septum retained thereby, the septum being arranged at least almost centrally relative to a longitudinal central axis and closing off one of two openings of the closing cap disposed opposite one another along the longitudinal central axis,

a device in the form of a container, in particular a storage container, e.g. for containing fluids of biological origin or biological assays, having a container interior partially delimited by a main container body comprising a container shell having an external and an internal shell surface and a container base arranged at one of two end faces of the container shell disposed at oppositely lying ends in the direction of a container central axis, the second end face of the container shell surrounding a container opening closed by a closure with a closure body comprising a closing cap and a septum retained thereby, the septum being arranged at least centrally relative to a longitudinal central axis closing one of two orifices of the closing cap arranged at opposing ends on the longitudinal central axis, and having at least one data medium,

and a method of identifying a device in the form of a container, in particular a storage container, e.g. for blood, whereby machine-readable data is stored on a data medium arranged on the device, in particular a memory chip for recording and reproducing and/or processing purposes.

2. The Prior Art

It has long been common practice to provide devices of the type mentioned above with some form of identification if these devices are to be used to receive products, e.g. fluids, in particular blood, if the products held in each container differ in respect of some of their properties or features. In analysing blood, these identification systems therefore play an important role in enabling blood samples taken from different people to be clearly categorised.

Hand written adhesive labels are often used for identification purposes or alternatively what are known as bar codes. The disadvantage of these, however, is that little is provided in terms of information content due to the restricted quantity of data.

A known approach is to use memory chips. DE 196 21 179 A1, for example, discloses a means of identification by running a method of identification and laboratory diagnosis on blood vessels. This means of identification consists of a transponder, which is connected along with the sample container to a carrying unit. The transponder is embedded in a socket made from plastic and this socket is connected to the base of the sample container, thereby providing a flat standing surface for the sample container. The socket and sample container are connected by means of adhesive.

A similar system is known from WO 96/07479 A. The container for the blood sample is prepared in such a way that a transponder is provided on its base by means of an additional holder. This holder is designed so that it can be inserted in the region of the base, which carries a risk that the sample container and memory device can become separated from one another so that the blood sample holder and its contents are no longer clearly identifiable.

A similar system for a sample holder for blood is known from EP 0 706 825 A1. This document describes a system whereby the memory chip is attached to a chip mounting or is cast therein, this chip mounting being either inserted in the rear open end of the sample container or attached to the sample container by means of a fitting piece. Although it is stated that a secure connection can be produced between the memory chip or chip mounting and the sample container, it would still possible for the two components to be come separated from one another using this system.

The disadvantage of the layout of the memory chip or chip mounting known from the prior art documents mentioned above is that additional components are needed, which increase the cost of manufacturing the container.

A method of analysing sample fluids is known from DE 43 26 342 A1, in which data media for the reagent solutions in the form of two-dimensional bar codes can be mounted on containers or, if the chip card is designed accordingly, in particular by encapsulation, can be enclosed in the container.

Finally, a system of identifying blood samples and/or the results of measurements taken on a patient is known from DE 43 33 615 A1, whereby the patient carries a data medium in the form of a memory device during his stay in hospital. This document also addresses the problem of identifying blood samples with the aid of data contained on the memory chip using another data medium which may be in the form of an adhesive label applied to the blood sample container.

### SUMMARY OF THE INVENTION

The underlying objective of this invention is to provide devices in the form of a container and/or closure with a data medium, which can be mass-produced without significantly increasing manufacturing costs compared with the conventionally known devices of this type.

This objective is achieved in that the at least one data medium is designed to record and reproduce and/or process data and is arranged on the container body by means of an appliance provided with an adhesive and/or in the container body, in particular being joined thereto and/or arranged in the container interior and/or joined thereto. The advantage of this system is that by using adhesive appliances, a semi-finished product containing the data medium can be pre-manufactured, simplifying the final assembly and in particular handling of the data medium. In addition, using the adhesive appliance allows the data medium to be attached to the device in a simple manner and this appliance protects the data medium from external influences.

The objective of the invention is also achieved in that at least one data medium designed for recording and reproducing and/or processing data is provided on or in the closure body, in particular is joined thereto. The advantage of this arrangement in addition to the advantages achieved by claim 1 is that, provided as a closure, the device can be re-used, for example on other containers having the same contents, and the data transferred along with the closure when it is transferred to the new container in readiness for processing the new container.

The device, in which the at least one data medium is designed to record and reproduce and/or process data and is arranged on the closure body and/or the container body, in particular being joined to these by an appliance provided with adhesive or being arranged in the container interior, also achieves the objective of the invention, the advantage of this arrangement being that the user of devices of this type has a wide variety of options for mounting the data medium on the device and devices of this type can be readily adapted to the respective purpose for which they are used.

Also of advantage is an embodiment, where the data medium is joined to the container shell, since on the one hand it enables the data medium and the appliance to be applied separately and on the other the connection used for the data medium on the container shell offers a further safety feature to prevent the data medium from becoming detached.

Also of advantage is an embodiment, where the data medium is arranged in the container shell, since the data medium can be protected from external influences.

Embodiments, where the data medium is joined to and/or arranged in the container base, are also of advantage, since the container shell is left free for applying another identification means.

Another advantage is, when the data medium is arranged on a surface of the closing cap directed away from the septum, that the data medium is readily accessible.

Also of advantage is an embodiment, where the data medium is arranged on a surface of the closing cap directed towards the septum, since the data medium can be mounted at a point that is protected as far as possible whilst nevertheless providing a contact, for example, in a simple and easy manner.

An embodiment, where the data medium is arranged in the closing cap, offers an advantage in that it does not hamper handling of the device and the user of the device does not have to take any special care of the data medium during handling.

Another advantageous embodiment, where the data medium is arranged in the septum, makes it easier to pierce the latter.

Another embodiment of the device, where data medium is a memory chip, is of advantage since the data can also be stored for future evaluation regardless of any further treatment or the future of the device.

Other possible embodiments make data transmission easier for the user.

The potential for errors when transmitting data is reduced by means of an embodiment, where the memory chip is designed for contact-dependent data transmission.

An embodiment, where the memory chip is attached to the container shell by means of an adhesive label made from paper or plastic, is of advantage since it offers the additional possibility of optically detectable hand written or machine-printed identification of the device.

By means of the embodiment, in which the memory chip is arranged between the adhesive label and the container body, the data medium can be protected from environmental influences in a simple manner, thereby enhancing the security of the data, for example.

The advantage offered by the design, where the memory chip is arranged between two layers of at least one partially multi-layered adhesive label, is that the data medium is mounted with the adhesive label in a single process step.

Also of advantage, however, is an embodiment, where the memory chip is arranged in a pocket of the adhesive label, since it offers a variant in which the user can remove the data medium from the device in a simple manner for subsequent evaluation of the data.

The advantage of the embodiment, where the adhesive label is provided with at least one recess in the region of the memory chip on the label surface directed away from the container interior, which is optionally made at least in one region from a material for establishing an electric contact, e.g. a gold film, and by means of which the contact with the memory chip is established in order to transmit data, is that defined regions are specifically provided for the data transmission so that the user can pre-position the device accordingly.

As a result of the embodiment, where the memory chip is cast in the container shell, the method used to manufacture the device is simplified and also offers good protection against deterioration of the data medium.

Also of advantage are the embodiments, where the memory chip is arranged and/or cast in the container base, by means of which the data can be transmitted through the container base, which means that the region of the container shell used for optical, for example photometric analysis of the device contents are not masked.

A multi-part device consisting of two containers inserted one inside the other, for example, again has the advantage of providing good protection for the data medium.

Also of advantage is a design, whereby manufacture of the device can be simplified due to the simple positioning of the data medium.

Another advantage is that there is no need to take particular account of specific designs of the container or closure body or their shape due to the film-design of the data medium.

The embodiment, where the data medium is designed to be electronically written on once only, is of advantage since, amongst other things, security of the data can be improved to prevent unauthorised manipulation.

Also of advantage are the embodiments, where the data medium is adhered to the container and/or closure body, since they provide a simple and durable means of mounting the data medium.

The objective of the invention is also achieved by a method, in which data is input at least partially by means of a speech recognition programme. The advantage is that the data input and data transmission can be simplified to the degree that people who find it difficult to work with electronic devices will have no problem in identifying devices.

Other embodiments of this method and the advantages achieved as a result can be found in the description.

### BRIEF DESCRIPTION OF THE DRAWINGS

To provide additional clarification, the invention will be explained in more detail below with reference to the appended drawings, wherein:

FIG. 1 is a schematic illustration of a device proposed by the invention with a data medium attached by means of an adhesive label;

FIG. 2 shows the device proposed by the invention with the data medium in a recess of the device;

FIG. 3 is another embodiment of the device proposed by the invention with two containers inserted one inside the other, the data medium being disposed between the two containers;

FIG. 4 is a simplified illustration of another embodiment of the adhesive label with a multi-layered design;

FIG. 5 is a simplified illustration of another embodiment of the adhesive label;

FIG. 6 is a simplified schematic illustration of the device proposed by the invention in the form of a closure, seen in section.

### DETAILED DESCRIPTION OF PREFERRED EMBODIMENTS

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

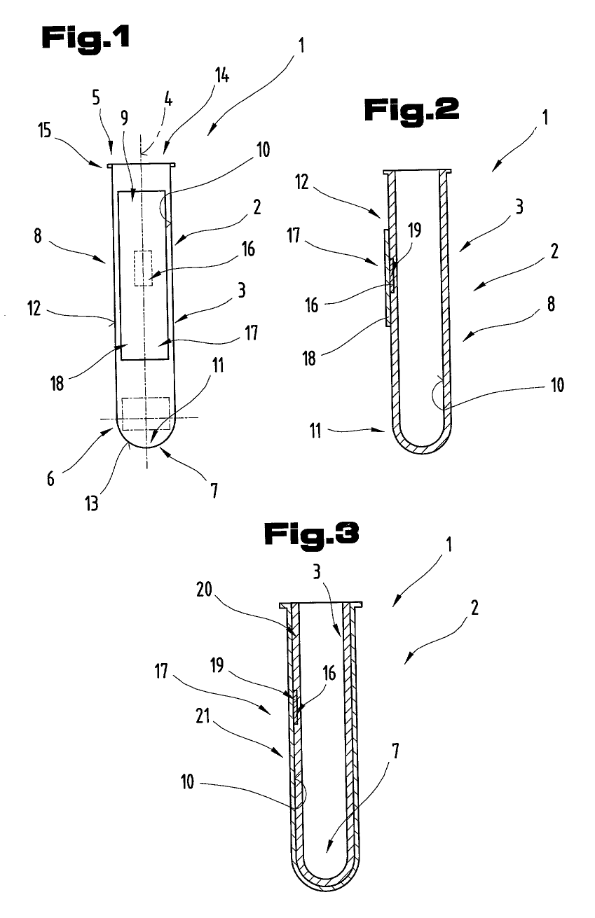

FIG. 1 illustrates a device 1 as proposed by the invention which may be designed in the form of a container 2, for example. This container 2 might be used as a container for holding fluids, for example, in particular of biological origin or biological assays, such as blood, urine or similar. Clearly, this container 2 could equally be used to hold other fluids, such as various reagents, for example, or designed to hold solids such as powders, and for this reason the shape of the container 2 described below should not be construed as being restrictive, it being possible for the container 2 to be designed to any shape appropriate for any purpose or any requirements.

By preference, the container 2 has a container shell 3, in the form of a tubular cylinder in particular, preferably having a circular cross section, for example. The container shell is delimited in the direction of a container central axis 4 by two end faces 5, 6 arranged opposite one another (the end face 6 is shown diagrammatically in FIG. 1). At least one of the two end faces 5, 6, preferably the end face 6, has a container base 7, as illustrated in FIG. 1, preferably integral therewith. Clearly, however, it would also be possible for this container base 7 to be joined to the container shell 3 by methods other than the method described here, for example bonded to the container shell 3. The container shell 3 together with the container base 7 forms a container body 8.

The container body 8 encloses a container interior 9, in which an internal shell surface 10 of the container shell 3 and an internal base surface 11 of the container base 7 are directed towards the container interior 9 whilst an external shell surface 12 and an external base surface 13 delimit the main container body 8 relative to the surrounding environment.

The container interior 9 is at least partially bounded by the main container body 8, a container opening 14 being provided at least partially in the region of the end face 5, by means of which the container interior 9 can be filled.

As may be seen from FIG. 1, at least one lip 15 may be provided in the region of this container opening 14, i.e. the end face 5, for example moulded thereon. By means of this lip 15, the container opening 14 can be closed, if necessary, to make it more difficult to inadvertently open the container 2. This lip 15 may be of a circumferential design, e.g. extending around the entire circumference of the end face 5, or alternatively this lip 15 could be of a discontinuous design. Clearly, instead of providing a lip 15, it would also be possible to provide a thread and it is merely be pointed out at this stage that the design of the lip 15 may be modified to suit the design of closure that will be used. As will be seen from the explanation below, this lip 15 may be dispensed with altogether if the container closure is designed accordingly.

For the purposes of the invention, the container 2 has at least one data medium 16. This data medium 16 may be designed to detect and reproduce and/or process data, an appropriate software programme being stored on the data medium 16 in the latter of these situations. By preference, the data medium 16 is disposed on, in particular joined to the container body 8 by an appliance 17 provided with adhesive. This appliance 17 may be an adhesive label 18, for example. If using the embodiment illustrated in FIG. 1, the data medium 16 may be arranged between the appliance 17 and the external shell surface 12 or this appliance 17 together with the data medium 16 could be applied at least partially in the region of the external base surface 13.

The appliance 17 may be a conventional adhesive label 18, in which case it will be possible to write on this adhesive label 18. The material used to make the appliance 17 might be paper, plastic or similar, for example.

Furthermore, the adhesive, for example a glue, could also be provided on the adhesive label and it would also be possible to provide adhesive on at least one surface of the data medium 16, although this is not absolutely necessary. If the appliance 17 is bigger than the data medium 16, the latter may be disposed so that it is completely masked by the appliance 17, which means that the data medium 16 can be prevented from being removed inadvertently.

The data medium 16 may be a memory chip which is preferably designed for storing digitised data. By preference, the data medium 16 is designed in the form of a film and may be made from a material with a plastic base, e.g. polyethylene terephthalate, on which conductive layers of a metal, e.g. aluminium, gold or similar, are applied. This thickness of this data medium 16 may be in the region of between 50 μm and 150 μm for example, in particular 75 and 120 μm, for example 86 μm, the advantage of this being that the data medium 16 will be barely perceptible when attached to the container 2, i.e. not penetrating or optically visible through the appliance 17. The same advantage can also be achieved if the thickness of the data medium is increased up to 500 μm. Clearly, it would also be possible to use data media in the form of a memory chip of a markedly different thickness from that specified, which is only given by way of example, the factor to be taken into account being that the data medium 16 must be removable from the exterior. However, it is preferable to use this film-type data medium 16 since it can be produced inexpensively and will therefore not significantly increase the price of the overall product, i.e. the price of the data medium 16 plus the container 2, which means that the data medium 16 does not necessarily have to be used again and can even be disposed of with the container 2 if necessary. This reduces the handling inherent in containers 2 of this type, for example blood containers, both during manufacture and during subsequent use.

Furthermore, it may be of advantage if the materials used for this data medium 16 and/or the appliance 17 are selected so as to ensure safe operation over a wide temperature range, for example between −70° C. and +150° C., in particular between −40° C. and +100° C., preferably between −25° C. and +70° C., e.g. so that it can be used for testing the container contents at different temperatures whilst in the container 2, in which case data compiled during these tests can be simultaneously and continuously stored on the data medium 16.

It may also prove to be of advantage if the materials used for the data medium 16 are selected so as to enable storage over longer periods, in particular at different temperatures, e.g. in the range of between −180° C. and +150° C., in particular between −80° C. and +90° C., preferably between −40° C. and +85° C. Accordingly, provided the container 2 is of an appropriate design, it will be possible to store blood samples at low temperatures, for example, to avoid degenerative deterioration of individual blood components.

The data medium 16 may also be designed so that it has contact surfaces, enabling contact-dependent data transmissions, for example by means of a reading and writing device. To this end, the appliance 17, for example the adhesive label 18, may be provided with at least one recess, in particular on the surface of the label directed away from the container interior 9, to allow the contact to be established with the data medium 16, for example the memory chip. Optionally, this recess may be provided with a material, at least in certain regions, conducive to establishing an electrical contact, for example a metal film of a conductive metal, e.g. a gold film, thereby improving the contact.

It would also be of advantage if the data medium 16 were designed so as to perform a contactless data transmission. To this end, the data medium 16 could co-operate with a transponder, for example, in order to establish the requisite data interface, the advantage of this arrangement being that the transponder can be operated without batteries, i.e. the energy needed to transmit data would be supplied from outside for each procedure. The data medium 16 and the transponder could therefore be designed as a single unit, in which case the data maybe transmitted with the aid of a transmitter, for example, which can be connected to a conventional PC.

Since transponder technology is already known from the prior art, no further details will be given here, this being a subject with which the skilled person is perfectly familiar.

In another embodiment, the data medium 16 may also be arranged inside the container 2, i.e. in the container interior 9. To this end, the data medium 16 or the unit needed to transmit data, e.g. with the transponder, can be encapsulated accordingly to prevent any adverse effects or deterioration of the unit. There will, of course, be no need for encapsulation if the container 2 is unlikely to be filled with an aggressive medium. In order to place the data medium 16 in the container interior, it could be loosely disposed, i.e. without any fixed connection to the container body 8 or alternatively this data medium 16 could also be placed on the shell surface 10 and/or base surface 11, in particular by means of adhesive.

It should be pointed out at this stage that all the embodiments described here in relation to the data medium may be used with the device 1 proposed by the invention and there will therefore be no need to describe them again.

FIG. 2 illustrates another embodiment of the device 1 proposed by the invention in a simplified schematic diagram viewed in section. Again, this device 1 is provided in the form of a container 2 and the appliance 17 is applied to the shell surface 12, although as with all the embodiments, this appliance 17 could be applied both to the shell surface 12 and to the base surface 11 or to both faces.

The container shell 3 of this embodiment is designed so that it has a depression or recess 19. The surface extension and volume of this recess 19 may be dimensioned so that it accommodates the data medium 16, e.g. the memory chip, as a whole, as a result of which the latter can be arranged on the container 2 flush with the shell surface 10. Here too, the data medium 16 may be masked by the appliance 17, for example the adhesive label 18.

Both the data medium 16 and the appliance 17 may be provided with an appropriate adhesive. On the other hand, adhesive can be dispensed with for the data medium 16. Accordingly, the data medium 16 may firstly be placed in the recess 19 and then covered with the appliance 17, thereby fixing it in position. Alternatively, the data medium 16 could be attached to the appliance 17 so that it can be assembled simultaneously when the appliance 17 is appended on the container 2.

It should be noted that in terms of size and extension, the recess 19 could be designed so that it is bigger than the dimensions of the data medium 16 to facilitate fitting of the data medium 16.

This recess might also be designed so that the data medium 16 partially stands out from the shell surface 10 and/or the base surface 11.

In another variant of this embodiment, the data medium 16 may be fully enclosed by the container body 8, in other words it could be embedded in the material used for the container body 8 during the process of manufacturing the container 2. For example, if the container 2 is to be made by an injection moulding process, the data medium 16 could be incorporated during the injection process or disposed in the mould at the appropriate point enabling the data medium 16 to be fully encapsulated. Similarly, the data medium 16, for example the memory chip, may be cast with the container body 8.

Another variant of the embodiment of FIG. 2 is schematically illustrated in FIG. 3. In this embodiment, the device 1, which is again in the form of a container 2, has two containers 20, 21. These containers 20, 21 are arranged so that the external dimensions of the container 20 are selected so that it fits inside the container 21. For example, the container 20 can be inserted in the container 21, preferably with virtually no clearance.

The container 20 illustrated in FIG. 3 again has a depression or recess 19, in which the data medium 16 may be placed. The data medium 16 may again be attached by an adhesive appliance 17, in which case the data medium 16 may be mounted beforehand either on the internal shell surface 10 of the container 21 or in this recess 19.

Because the two containers 20, 21 are inserted one inside the other, the data medium 16 can be protected from environmental influences as far as possible, which means that no other system,. e.g. appliance 17, is necessary. Clearly, however, this appliance 17 may be provided, for example on the external surface of the container 21 so that it can be manually written on, thereby identifying the device 1 proposed by the invention.

Although not illustrated in FIG. 3, it is also possible for the container 20 of this embodiment to be designed so that it comprises merely a part of the container shell 3, i.e. the container base 7 can be dispensed with for example. In this embodiment, therefore, the container 20 will essentially be in the form of a sleeve which may bear the data medium 16, for example. Alternatively, with the embodiment of the data medium 16 described, it would also be possible to dispense with the recess 19.

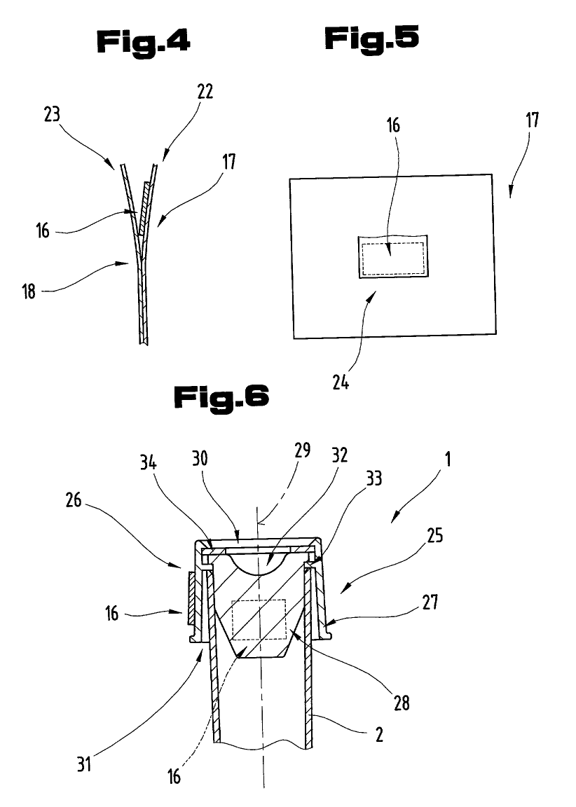

FIG. 4 provides a simplified diagram of an embodiment of the appliance 17. This appliance 17 may be made up of at least two layers, namely a first layer 22 and a second layer 23 and this multi-layered structure is illustrated in FIG. 4. It is now possible to arrange the data medium 16 between these layers, so that this data medium 16 is encapsulated so to speak since the individual layers 22, 23 are joined to one another again after the data medium 16 has been inserted, for example by sticking. Accordingly, the process of mounting the data medium 16 on the device 1 proposed by the invention (see FIGS. 1 to 3) can be facilitated and conventional methods may be used to make this device 1 since it has always been common practice to apply adhesive labels to devices 1 of this type.

Clearly, this appliance 17, the adhesive label for example, may have additional layers and it will therefore be possible to protect the data medium 16 from environmental influences if, for example, the layered structure is provided in such a way that diffusion of liquid vapours is prevented by what is referred to as a barrier layer known from the prior art.

In this connection, it should be noted that with the embodiment illustrated in FIG. 3, it would also be possible to select the materials used for the containers 20, 21 so that these containers 20, 21 fulfil different functions. For example, one of the containers 20, 21, e.g. the outer one, could be made from polyethylene terephthalate, which is characterised by its good barrier effect with regard to the permeability of gases, e.g. oxygen, carbon monoxide, etc., in other words oxidative media in particular. The inner container 20 might be made from polypropylene for example, which exhibits a good barrier effect with regard to steam and can therefore protect the data medium 16 from influences such as corrosion originating in the container interior 9.

Other possible examples of plastics which may be used for the containers 20, 21 and the appliance 17 are PEN, PVDC, PVA, EVOH, PA, PE, PVC, PC, PAN and PS, their arrangement being selected so as to fulfil specific functions withub a multi-layered structure of the appliance 17 or multi-part structure of the device 1 depending on the properties of these plastics.

Alternatively, however, if the container 2 is designed to hold liquids, the purpose of the inner container 20 would be to provide impermeability to the liquid and materials which do not exhibit this inherent property could be used for the container 21.

In the embodiment illustrated in FIG. 3, it would therefore be possible to select a layer structure whereby the overall property of the container 2 meets the desired requirements.

FIG. 5 provides a diagrammatic illustration of another variant of the appliance 17, which has a sort of pocket 24, i.e. a second layer is provided on at least a region of the appliance 17 and so mounted that the data medium 16 can be inserted in this pocket 24. Clearly, however, this embodiment of the appliance 17 could also have other layers.

In FIG. 6, the device 1 proposed by the invention is schematically illustrated in the form of a closure 25.

The embodiment chosen to illustrate the closure 25 is that of a container for blood although it should be pointed out that this type of closure 25 does not restrict the scope of the invention and other designs, for example in the form of simple screw caps for containers 2 may also be selected.

The closure 25 illustrated as an example in FIG. 6 may comprise a closure body 26, which in this case has at least one closing cap 27 in which a septum 28 is retained. For the septum 28, it is preferable to select self-sealing elastic materials, such as rubber, which can be pierced.

The septum 28 is arranged at least almost concentrically with a longitudinal central axis 29 and seals off at least one of two orifices 30, 31 of the closing cap 27 lying at opposing ends of this longitudinal central axis 29.

It should be noted here that closures 25 of this type for blood-containing vessels are known from the prior art and their design will therefore not be described in any further detail, being familiar to the skilled person. In the region of the opening 30,the septum could have a recess 32, for example, by means of which the septum 28 can be more easily pierced by a cannula.

Furthermore, this septum 28 might also be retained in the closing cap 27 by means of a matching lip 33 and retaining device 34, e.g. in the form of a plate with an appropriate opening in the region of the longitudinal central axis 29.

FIG. 6 also partially illustrates the container 2 sealed off by the closure 25 and the way in which the closure 25 may be retained on the container 2, making use of the static friction of the septum 28 on the internal container wall for example. Alternatively, of course, appropriate additional features could be provided, such as a thread or other lips which would locate in matching regions of the closing cap.

For the purposes of the invention, at least one data medium 16, for example a memory chip, is provided on the closure 25 and reference may be made to the embodiments described above for details of the design of the data medium 16. As with all the embodiments, the data medium 16 may be designed so that it can be written on once only and the data contained on the data medium could be protected to prevent further editing, e.g. by unauthorised persons. To this end, the data medium will incorporate precautions, which may also be in the form of an appropriate software programme for example, which destroy the writing line after it has been used for writing purposes for the first time.

The data medium 16 can be arranged either on at least one surface of the closing cap 27, for example the external and/or internal surface facing the container 2, or these data media 16 may be arranged at some other point of the closure body 26, e.g. on or in the septum 28. Again, this may be a mounting using an adhesive, for example a bonding means, so that this data medium 16 is permanently fixed to the closure body 26. The data medium 16 could also be mounted using an appliance 17 (not illustrated in FIG. 6).

The embodiment in which the data medium 16 is arranged in the internal surface of the closing cap 27 directed towards the container offers the advantage of protecting the data medium as far as possible from external influences, for example inadvertent tearing or simply prevents contact by the user. If, in this case, the data medium is equipped to enable data transmissions requiring a contact, there will of course be a possibility of providing appropriate orifices in the closing cap 27 so that this contact can be established.

If the data medium 16 is to be disposed in the septum 28, care will clearly need to be taken to ensure that the data medium 16 can not be broken when the septum 28 is punctured by a cannula of the data medium 16 and it is of particular advantage if this data medium 16 is embedded in the external region of the septum 28.

Clearly, if the device 1 is used in the embodiment illustrated in FIG. 6, matching recesses for the data medium 16 can be provided on the closure body (not illustrated in FIG. 6).

The device 1 proposed by the invention may also be designed in the form of a container 2 which is sealed by the closure 25 and at least one data medium may be provided both on the closure 25 and in the container 2.

For example, at least one data medium could be provided on the container body 8 and/or on the closure body 26, which would firstly increase the capacity available for the data to be stored on the device 1 proposed by the invention. Secondly, different data could be stored in separate locations enabling simultaneous processing of these data sets. Furthermore, this would enable a simple system of authorised access to the data to be set up for specific authorised personnel without the need to take specific precautions with a single data medium, although this would of course also be possible.

The data input or data readout may be operated in a conventional manner, for example from the keyboard of a PC or automatically by means of appropriate contacts, during a measuring process for example. Alternatively, it would also be possible to input data using a speech recognition programme, thereby simplifying routine operations using devices 1 proposed by the invention, which also means that data can be entered by anybody, including those with no prior knowledge of computer systems. This speech recognition programme may be either stored on a PC or could be stored directly on the data medium 16 if the data medium 16 were designed to have an appropriate storage medium. This is of advantage if data is transmitted contactlessly, in other words via a transponder, thereby simplifying the equipment required on site.

In this case, data may be entered by means of an acoustic/electric signal converter, for example a microphone, it also being possible for this signal converter to be integrated in a conventional PC.

Prior to transmitting data, the data medium 16 should be attached by means of the appliance 17, for example the adhesive label 18, to the device 1 proposed by the invention, since this will prevent the data medium from being mixed up with several other devices 1 during routine operations. Clearly, however, another option would be to transmit the data prior to attaching the data medium 16 to the device 1.

Examples of the data which might be stored are the nature and/or quantity of the device contents, any prior treatment undergone, e.g. irradiation treatment applied to the device, storage conditions such as the storage temperature of the device 1 for example as well as data relating to the source of the contents, e.g. data specifically relating to persons in the case of blood containers. Other data could also conceivably be stored, for example the records of relevant data resulting from analysis of the contents of the device 1, in which case this can also be transmitted during the analysis.

For the sake of good order, it should finally be pointed out that in order to provide a clearer understanding of the structure of the device 1, it and its constituent parts have been illustrated out of scale to a certain extent and/or on an enlarged and/or reduced scale.

The tasks underlying the independent inventive solutions can be found in the description. Above all, the subject matter illustrated in the individual embodiments depicted in FIGS. 1; 2; 3; 4; 5; 6 can be construed as independent solutions proposed by the invention. The tasks and solutions can be found in the detailed descriptions relating to these drawings.

What is claimed is:

1. Device in the form of a container, in particular a storage container, e.g. for containing fluids of biological origin or biological assays, having a container interior partially delimited by a main container body comprising a container shell having an external and an internal shell surface and a container base arranged at one of two end faces of the container shell disposed at oppositely lying ends in the direction of a container central axis, the second end face of the container shell surrounding a container opening, and at least one data medium, characterised in that the at least one data medium is designed to record and reproduce and/or process data and is arranged on the container body by means of an appliance provided with an adhesive and/or in the container body, in particular being joined thereto and/or arranged in the container interior and/or joined thereto.

2. Device in the form of a closure for a container opening, having a closure body comprising a closing cap and a septum retained thereby, the septum being arranged at least almost centrally relative to a longitudinal central axis and closing off one of two openings of the closing cap disposed opposite one another along the longitudinal central axis, characterised in that at least one data medium designed for recording and reproducing and/or processing data is provided on or in the closure body, in particular is joined thereto.

3. Device in the form of a container, in particular a storage container, e.g. for containing fluids of biological origin or biological assays, having a container interior partially delimited by a main container body comprising a container shell having an external and an internal shell surface and a container base arranged at one of two end faces of the container shell disposed at oppositely lying ends in the direction of a container central axis, the second end face of the container shell surrounding a container opening closed by a closure with a closure body comprising a closing cap and a septum retained thereby, the septum being arranged at least centrally relative to a longitudinal central axis closing one of two orifices of the closing cap arranged at opposing ends on the longitudinal central axis, and having at least one data medium, characterised in that the at least one data medium is designed to record and reproduce and/or process data and is arranged on the closure body and/or the container body, in particular being joined to these by an appliance provided with adhesive or being arranged in the container interior.

4. Device as claimed in one of the preceding claims 1 to 3, characterised in that the data medium is joined to the container shell.

5. Device as claimed in one of the preceding claims 1, 3 and 4, characterised in that the data medium is arranged in the container shell.

6. Device as claimed in one of the preceding claims 1 and 3 to 5, characterised in that the data medium is joined to the container base.

7. Device as claimed in one of the preceding claims 1 and 3 to 6, characterised in that the data medium is arranged in the container base.

8. Device as claimed in one of the preceding claims 2 or 3, characterised in that the data medium is arranged on a surface of the closing cap directed away from the septum.

9. Device as claimed in one of the preceding claims 2 or 3, characterised in that the data medium is arranged on a surface of the closing cap directed towards the septum.

10. Device as claimed in one of the preceding claims 2, 3, 8 and 9 characterised in that the data medium is arranged in the closing cap.

11. Device as claimed in one of the preceding claims 2, 3 and 8 to 10, characterised in that the data medium is arranged in the septum.

12. Device as claimed in one of the preceding claims, characterised in that the data medium is a memory chip.

13. Device as claimed in one of the preceding claims, characterised in that the memory chip is designed for contactless data transmission.

14. Device as claimed in one of the preceding claims, characterised in that the memory chip co-operates with a transponder.

15. Device as claimed in one of the preceding claims, characterised in that the memory chip and the transponder form one unit.

16. Device as claimed in one of the preceding claims, characterised in that the memory chip is designed for contact-dependent data transmission.

17. Device as claimed in one of the preceding claims 1, 3 to 8 and 12 to 16, characterised in that the memory chip is attached to the container shell by means of an adhesive label made from paper or plastic.

18. Device as claimed in one of the preceding claims 1, 3 to 8 and 12 to 17, characterised in that the memory chip is arranged between the adhesive label and the container body.

19. Device as claimed in one of the preceding claims, characterised in that the memory chip is arranged between two layers of at least one partially multi-layered adhesive label.

20. Device as claimed in one of the preceding claims, characterised in that the memory chip is arranged in a pocket of the adhesive label.

21. Device as claimed in one of the preceding claims 1, 3 to 8 and 12 to 20, characterised in that the adhesive label is provided with at least one recess in the region of the memory chip on the label surface directed away from the container interior, which is optionally made at least in one region from a material for establishing an electric contact, e.g. a gold film, and by means of which the contact with the memory chip is established in order to transmit data.

22. Device as claimed in one of the preceding claims 1, 3 to 8 a nd 12 to 21, characterised in that the memory chip is cast in the container shell.

23. Device as claimed in one of the preceding claims 1, 3 to 8 and 12 to 22, characterised in that the memory chip is arranged in the container base.

24. Device as claimed in one of the preceding claims 1, 3 to 8 and 12 to 23, characterised in that the memory chip is cast in the container base.

25. Device as claimed in one of the preceding claims 1, 3 to 8 and 12 to 24, characterised in that the container body is of a multi-part design and the data medium is arranged between these parts.

26. Device as claimed in one of the preceding claims 1, 3 to 8 and 12 to 25, characterised in that the memory chip is inserted between two containers at least partially forming the container body.

27. Device as claimed in one of the preceding claims 1, 3 to 8 and 12 to 26, characterised in that at least one container has a recess in the region of the data medium of at least the size of the surface area extension of the data medium which at least partially houses the memory chip.

28. Device as claimed in claim 27, characterised in that the data medium is wholly received in the recess.

29. Device as claimed in one of the preceding claims, characterised in that the data medium is provided in the form of a film.

30. Device as claimed in one of the preceding claims, characterised in that the data medium is designed to be electronically written on once only.

31. Device as claimed in one of the preceding claims 1, 3 to 8 and 12 to 30, characterised in that the data medium is adhered to the container body.

32. Device as claimed in one of the preceding claims 2, 3 to 8 to 16, 29 and 30, characterised in that the data medium is adhered to the closure body.

33. Method of identifying a device in the form of a container, in particular a storage container, e.g. for blood, whereby machine-readable data is stored on a data medium arranged on the device, in particular a memory chip for recording and reproducing and/or processing purposes, characterised in that data is input at least partially by means of a speech recognition programme.

34. Method as claimed in one of the preceding claims, characterised in that the data is transmitted contactlessly via a transponder.

35. Method as claimed in one of the preceding claims, characterised in that data relating to the nature and/or quantity of a device content and/or prior treatment, e.g. irradiation treatment of the device and/or the storage conditions, e.g. a storage temperature of the device and/or the source of the contents, e.g. personal data, are stored.

36. Device as claimed in one of the preceding claims, characterised in that the data medium is attached to the device by means of an adhesive label prior to transmitting data.
